(19) United States
(12) Patent Application Publication
(10) Pub. No.: US 2026/0112342 A1
(43) Pub. Date: Apr. 23, 2026

(54) UNIVERSAL DRUM ACCESSORY MOUNT

(71) Applicant: Joshua Allen, Schoolcraft, MI (US)

(72) Inventor: Joshua Allen, Schoolcraft, MI (US)

(21) Appl. No.: 18/922,526

(22) Filed: Oct. 22, 2024

(51) Int. Cl. G10D 13/10

(52) U.S. Cl. CPC G10D 13/28

(57) ABSTRACT

A universal drum accessory mount is disclosed. The universal drum accessory mount is comprised of a slotted bracket and two rotational clips. The rotational clips are comprised of a twist fastener and a lower clip base. The twist fasteners are attached to the lower clip bases with a threaded fasteners, the twist fasteners being on one side of the slotted bracket and the lower clip bases being on the other side of the slotted bracket. The two rotational clips are intended to capture the tension rod of a drum. The two rotational clips as positioned at a first length apart from one another on the slotted bracket. The first length corresponds with the distance between tension rods on the drum.

### FIELD OF INVENTION

This invention relates to the class of music. Specifically, this invention relates to the sub-classes of instruments, drums, and supports.

### BACKGROUND OF INVENTION

Drummers use drum kits comprised of a number of drums that are configured to the drummers preference. A drum kit requires a substantial amount of time to set up and break down when changing its location. A drum kit has many accessories, each of which needs to be properly attached including, but not limited to, cowbells, cymbals, kick pedals, microphones, and stick bags.

Drummers are always seeking a cost-effective way in which to reduce the time needed to set up and break down their equipment. The invention disclosed in this application, allows for quick attachment and detachment of a wide variety of drum accessories to a drum kit.

### SUMMARY OF THE INVENTION

This summary is intended to disclose the present invention, a universal drum accessory mount that allows for quick set up and break down without altering the sound of the drums. The embodiments and descriptions are used to illustrate the invention and its utility, and are not intended to limit the invention or its use. The present invention, a universal drum accessory mount is comprised of two rotational clips and a slotted bracket. The rotational clip is comprised of two pieces: an upper twist fastener and a lower clip base. In normal configurations, the slotted bracket has at least one slot and at least one other opening.

The twist fastener has a lower surface, a lower edge, a first top surface, a second top surface, a middle top surface, a lateral surface, a semi-circular curved surface, and an grasping face. There is a through-hole in the middle top surface through which the threaded fastener fits.

The lower clip base has two bottom surfaces, a first inner surface, a second inner surface, a lateral face, a side surface, a mating surface, a first approximately semi-cylindrical surface, a second approximately semi-cylindrical surface, a first beveled surface and a second beveled surface. In the preferred embodiment, the first and second approximately semi-cylindrical surfaces are slightly more than a half-cylinder in the longitudinal axis of the cylinder. The first and second approximately semi-cylindrical surfaces have a retaining lip. The first and second approximately semi-cylindrical surfaces each adjoin a beveled surface. The lower surface of the twist fastener abuts the mating surface of the lower clip base when the two parts are joined together. The first approximately semi-cylindrical surface is disposed 180° with respect to the second approximately semi-cylindrical surface. In other words, the opening of the first approximately semi-cylindrical surface is the opposite direction from the opening of the second approximately semi-cylindrical surface. The first approximately semi-cylindrical surface and the second approximately semi-cylindrical surface are aligned in a straight line, meaning that a straight rod can simultaneously fit through both of them.

The lower clip base has an anti-rotation feature which keeps the lower clip base from turning independent of the twist fastener. The anti-rotation feature is a conical protrusion having a horizontal surface, a lateral surface, a top surface, and a through-hole. The threaded fastener fits through the through-hole. The anti-rotation feature of the lower clip base mates with a mating feature inset in the lower surface of the twist fastener. The threaded fastener and nut are used to attach the twist faster and lower clip base to one another.

The twist fastener and lower clip base can be fabricated from any dimensionally stable engineered polymer including, but not limited to, poly(methyl-methacrylate) (“PMMA” or tradenames Plexiglass or Lucite®), polycarbonate (“PC” or tradename Lexan®), acrylonitrile butadiene styrene (“ABS”), polypropylene (“PP”), high-density polyethylene (“HDPE”), low-density polyethylene (“LDPE”), polyethylene (“PE”), polyethylene terephthalate (“PET”), and polylactic acid (“PLA”).

In most embodiments, the slotted bracket is generally rectangular with rounded corners. It has a a first surface, a second surface, and at least two openings, one of which is a slot. The first surface is obverse to the second surface. The twist fastener is placed on a first surface, the lower clip base is placed on a second surface, and the threaded fastener is tightened to the hex nut to provide a snug fit which still allows the twist fastener and lower clip base to be rotated while attached to the slotted bracket. The anti-rotational feature prevents the twist fastener and the lower clip base from rotating independent of one another.

The universal drum accessory mount can be used to quickly attach accessories to a drum kit because the lower clip base can engage and retain the tension rods found on most drums. A user aligns the beveled surfaces of the first and second approximately semi-cylindrical surfaces of the lower clip base with the tension rod and then twists the grasping face of the twist fastener in a clockwise direction. Due to the anti-rotation feature, the lower clip base will rotate with the twist fastener so that the tension rod is captured in the first and second approximately semi-cylindrical surfaces. The beveled surfaces adjacent to each approximately semi-cylindrical surface facilitate the engagement between the tension rod and the lower clip base. The retaining lip of the first and second approximately semi-cylindrical surfaces hold the tension rod securely in place, and secure the slotted bracket to the tension rods. In this way, a variety of accessories can be attached to the tension rods on a drum using the universal drum accessory mount.

A wide variety of accessories can be attached to the slotted bracket, such as cymbal holders, microphone holders, kick-pedals, cowbell holders, stick holders, cellphone holders, and tablet holder. It can also be used with bass drum risers and floor tom to bass drum conversions. Almost any accessory or structure that is intended to be attached to a drum can be more quickly attached to a drum using the universal drum accessory mount.

### BRIEF DESCRIPTION OF THE DRAWINGS

The present invention is illustrated with 14 drawings on 12 sheets.

FIG. 1 is bottom view of the rotational clip.

FIG. 2 is a perspective view of the rotational clip.

FIG. 3 is a perspective view of the bottom of the twist fastener showing a mating feature inset.

FIG. 4 is an exploded view of the rotational clip.

FIG. 5A is a perspective isolation of the rotational clips attached to a slot in a bracket, creating the universal drum accessory mount. FIG. 5B is a bottom isolation of the universal drum accessory mount.

FIG. 6A is a perspective view of the universal drum accessory mount attached to a cymbal holder, with one rotational clip in a hole and one rotational clip in a slot. FIG. 6B is a side view of a floor tom drum. FIG. 6C is a side view of a floor tom drum with a cymbal attached using the universal drum accessory mount.

FIG. 7 is a side view of two rotational clips attaching a stickholder to a floor tom drum.

FIG. 8 is a perspective view of a universal drum accessory mount attaching a cowbell holder to a drum.

FIG. 9 is a universal drum accessory mount attached to a kick-pedal base.

FIG. 10 is a bottom isolation of a universal drum accessory mount attached to a kick-pedal base attached to a drum.

FIG. 11 is a close-up isolation of a universal drum accessory mount attached to a kick-pedal base, which in turn, is attached to a bass drum and the kick-pedal.

FIG. 12 is a perspective isolation of the kick pedal being attached to the bass drum the present invention.

FIG. 13 is an isolation of a universal drum accessory mount attached to a microphone bracket.

FIG. 14 is a perspective isolation of a universal drum accessory mount attaching a microphone holder to a drum.

### DETAILED DESCRIPTION OF THE DRAWINGS

The following descriptions are not meant to limit the invention, but rather to add to the summary of invention, and illustrate the present invention, a universal drum accessory mount. The present invention is illustrated with a variety of drawings showing various possible embodiments.

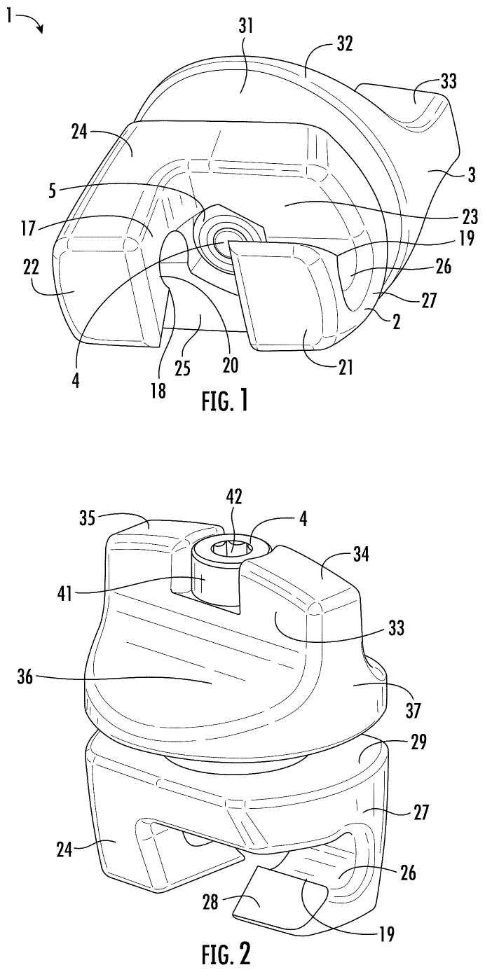

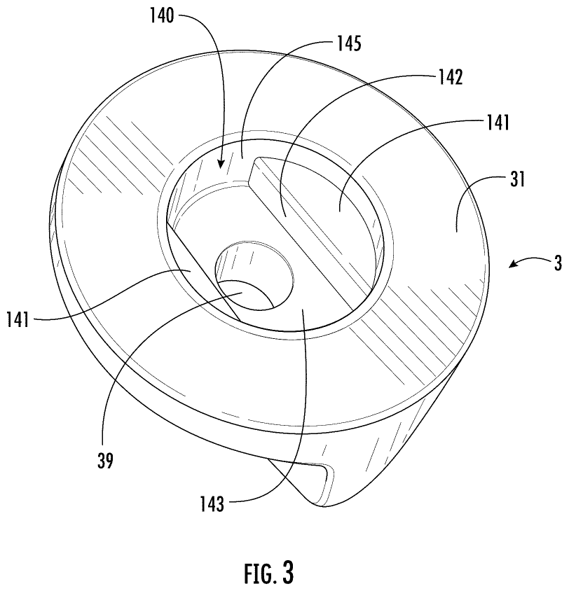

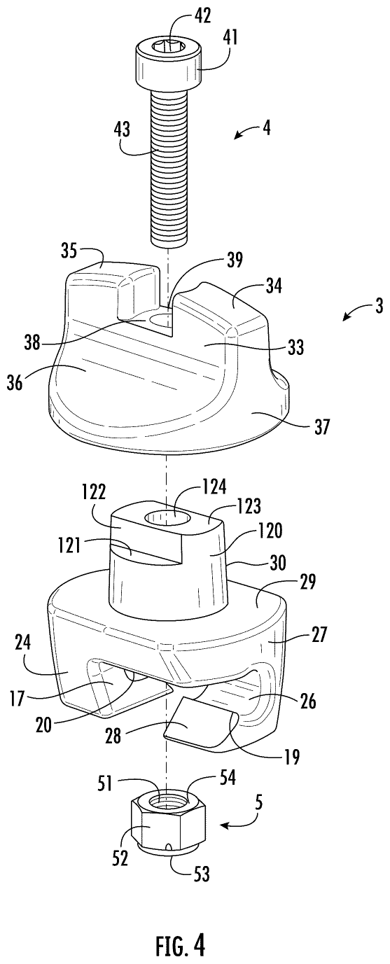

In FIGS. 1-4, a rotational clip 1, is comprised of two pieces: a twist fastener 3 and a lower clip base 2. The twist fastener 2 has a lower surface 31, a lower edge 32, a first top surface 34, a second top surface 35, a lateral surface 37, a semi-circular curved surface 36, and an grasping face 33.

Between the first top surface 34 and the second top surface 35 is a middle top surface 38. There is a through-hole 39 in the middle top surface 38 through which the threaded fastener 4 fits.

The lower clip base 2 has two bottom surfaces 21, 22, a first inner surface 25, a second inner surface 23, a lateral face 24, side surface 27, a mating surface 29, a first approximately semi-cylindrical surface 26, and a second approximately semi-cylindrical surface 20. The first and second approximately semi-cylindrical surfaces 26, 20, have a retaining lip 18, 19.

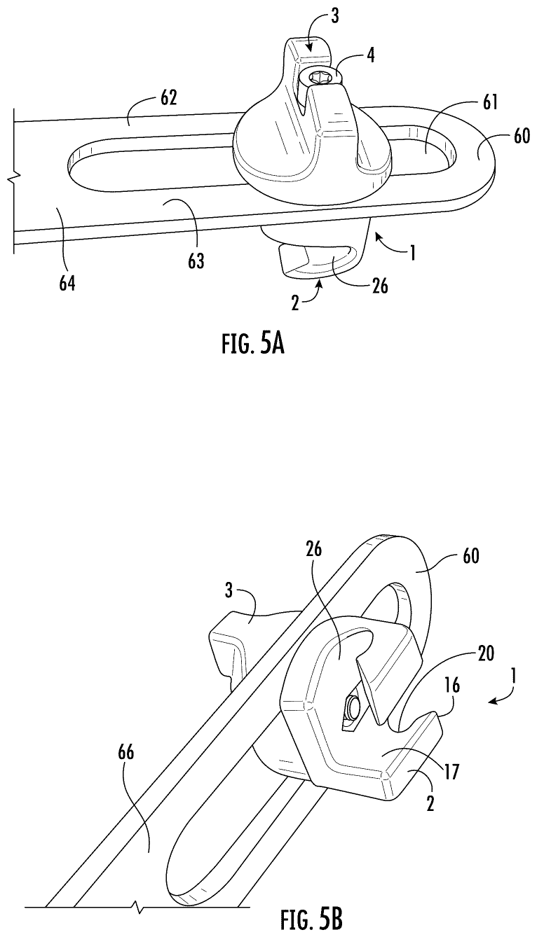

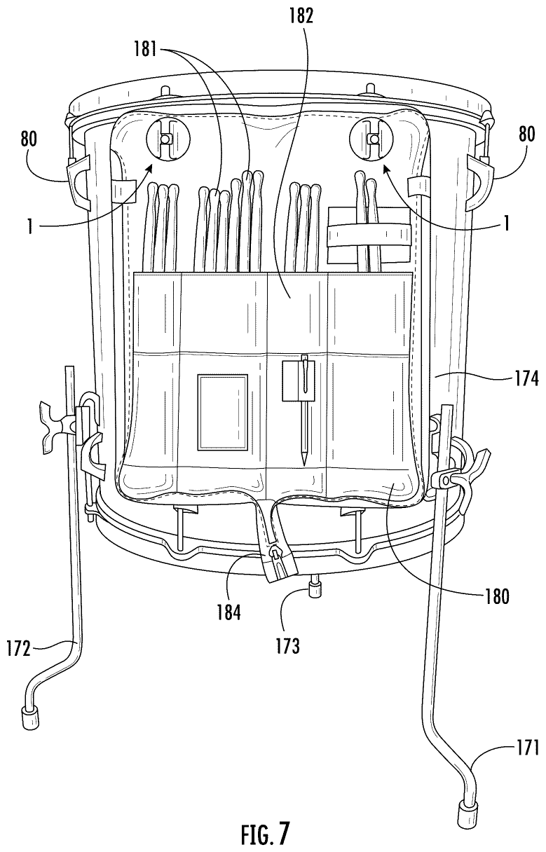

The first and second approximately semi-cylindrical surfaces 26, 20, each adjoin a beveled surface 28, 16 (16 is a beveled edge of the beveled surface which is visible in FIG. 5). The first and second approximately semi-cylindrical surfaces 26, 20 each have an inner lateral surface 17 (the inner lateral surface of the first approximately semi-cylindrical surface 26 is not visible). The first approximately semi-cylindrical surface 26 is disposed 180° with respect to the second approximately semi-cylindrical surface 20. In other words, the opening of the first approximately semi-cylindrical surface 26 is the opposite direction from the opening of the second approximately semi-cylindrical surface 20. The first approximately semi-cylindrical surface 26 and the second approximately semi-cylindrical surface 20 are identical except they point in opposite directions. The first approximately semi-cylindrical surface 26 and the second approximately semi-cylindrical surface 20 are aligned in a straight line, meaning that a straight rod can simultaneously fit through both of them. The lower surface 31 of the twist fastener 3 abuts the mating surface 29 of the lower clip base 2, when the two parts are attached by the threaded fastener 4 and nut 5. The first and second approximately semi-cylindrical surfaces 26, 20 are sized to accommodate a standard drum tension rod 81 (FIG. 7 for example).

The lower clip base 2 has an anti-rotation feature 30, which keeps the lower clip base 2 from turning independent of the twist fastener 3. The anti-rotation feature 30 is a conical protrusion 120 having a horizontal surface 121, a lateral surface 122, a top surface 123 and a through-hole 124. The threaded fastener 4 fits through the through-hole 124. The anti-rotation feature 30 of the lower clip base 2 mates with a mating feature inset 140 in the lower surface 31 of the twist fastener 3.

The mating feature inset 140 in the lower surface 31 of the twist fastener 3 has a rim 141, a through hole 39, a cylindrical side surface 145, a lower horizontal surface 143, an upper horizontal surface 141, and a lateral surface 142. The anti-rotation feature 30 of the lower clip base 2 mates snuggly with the mating feature inset 140 of the twist fastener 3.

A threaded fastener 4 with its head 41 visible on the twist fastener 2 threads with a hex nut 5 captured by the lower clip base 2. The head 41 of the threaded fastener 4 has hexagonal interior 42 that mates with an appropriate hex key or Allen wrench. The threaded shaft 43 of the threaded fastener 4 fits through the through-hole 39 in the twist fastener 3 and the through-hole 124 in the lower clip base 2, terminated in the hex nut 5. The hex nut 5 has a segmented side surface 52, a top surface 54, a bottom surface 53, and inner threads 51.

The twist fastener 3 and lower clip base 2 can be fabricated from any dimensionally stable engineered polymer including, but not limited to, poly(methyl-methacrylate) (“PMMA” or tradenames Plexiglass or Lucite®), polycarbonate (“PC” or tradename Lexan®), acrylonitrile butadiene styrene (“ABS”), polypropylene (“PP”), high-density polyethylene (“HDPE”), low-density polyethylene (“LDPE”), polyethylene (“PE”), polyethylene terephthalate (“PET”), and polylactic acid (“PLA”).

FIGS. 5A and 5B show the present invention, two rotational clips 1 mated with a slotted bracket 60. The slotted bracket 60 has a slot 61, a first member 62 and a second member 63. The twist fastener 3 is placed on a first surface 64, the lower clip base 2 is placed on a second surface 66 and the threaded fastener 4 is tightened to the hex nut 5 to provide a snug fit which still allows the twist fastener 3 and lower clip base 2 to be rotated. The anti-rotational feature 30 prevents the twist fastener 3 and the lower clip base 2 from rotating with respect one another.

The first and second approximately semi-cylindrical surfaces 26, 20 of the lower clip base 2 are visible in FIG. 5. The inner lateral surface 17 adjacent to the second approximately semi-cylindrical surface 20 is also visible. The present invention 1, 60, can be used to attach a variety of accessories to a drum.

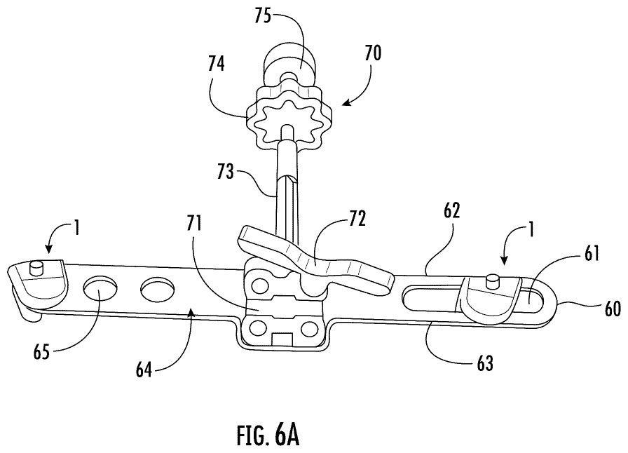

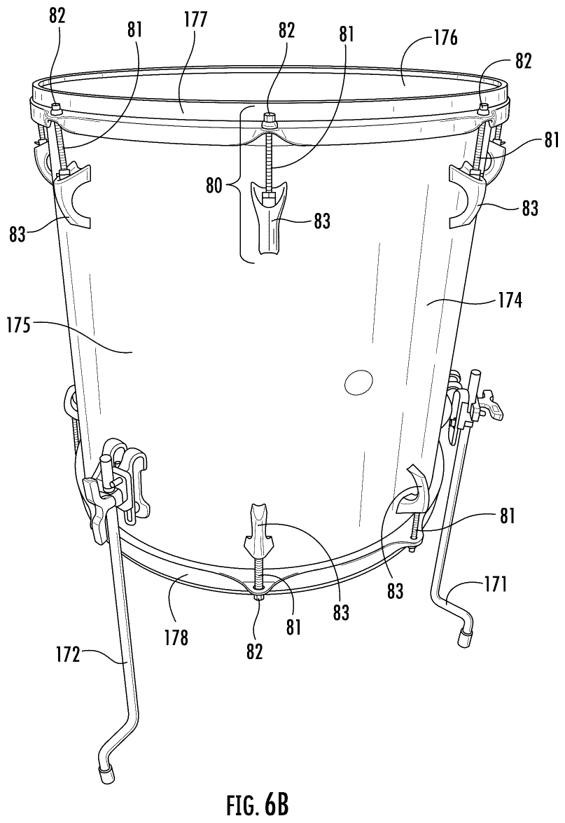

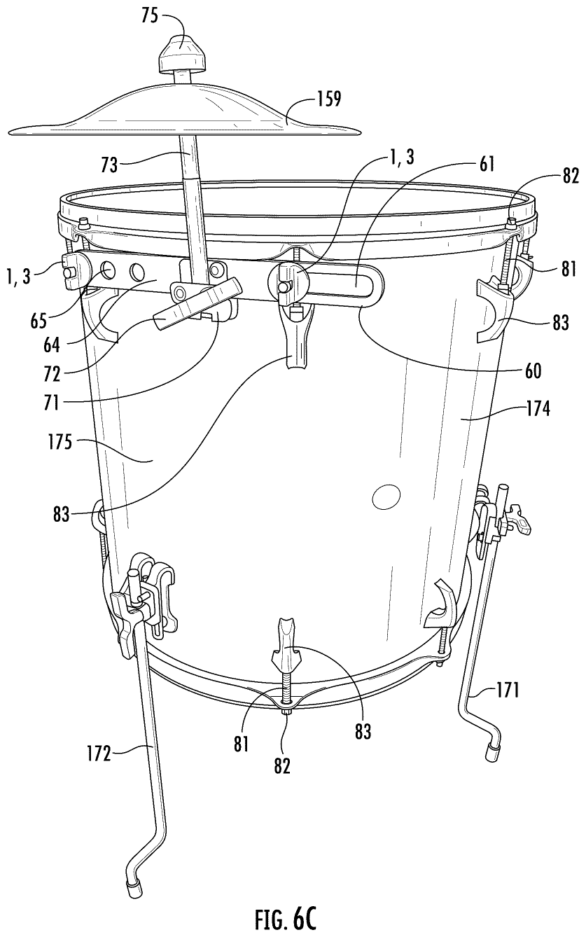

FIG. 6A shows two rotational clips 1 attached to a slotted bracket 60 mated with the cymbal holder 70. One rotational clip 1 is attached to a slot 61 between the first member 62 and the second member 63. The second rotational clip 1 is attached to a hole 65 on the first surface 64 of the slotted bracket 60. The slotted bracket has at least one hole 65. The cymbal holder 70 has a base 71, a tuning key 72, a stem 73, a support 74, and a cap 75.

The base 71 connects the cymbal holder 70 to the slotted bracket 60. The tuning key 72 is used to tighten the stem 73 within the base 71. The cymbal is mounted on the support 74 and held in place by the cap 75.

FIG. 6B shows a floor tom drum 174. The floor tom drum has three legs 171, 172, 173 (173 is not visible due to the perspective); a cylindrical shell 175, a membrane 176, a upper hoop 177, a lower hoop 178, and a plurality of drum tensioners 80. A drum tensioner 80 is comprised of three pieces: the tension bolt 82, a tension rod 81, and a lug 83. The tension bolt 82 fits through the hoop 177 and threads snuggly to the tension rod 81. The tension rod 81 also threads into the lug 83.

FIG. 6C shows the cymbal 159 mounted to the floor tom drum 174 using the rotational clips 1 and slotted bracket 60. One rotational clip 1 is attached through a hole 65 on the left-side of the first surface 64 of the slotted bracket 60. The twist fastener 3 of the rotational clip 1 is pointing outward from the floor tom drum 174 and is visible. A second rotational clip 1 is attached to a slot 61 on the right-side of the slotted bracket 60. In order to fasten the universal drum accessory mount 1, 60 and cymbal 159 to the floor tom drum 174, each of the two rotational clips 1 are aligned with a tension rod 81. The twist fastener of the first rotational clip is rotated until the tension rod is captured by the first and second approximately semi-cylindrical surfaces 26, 20 of the lower clip base 2. Then, the twist fastener of the second rotational clip is rotated until the tension rod is captured by the first and second approximately semi-cylindrical surfaces 26, 20 of the lower clip base 2. Also visible in FIG. 6C are the cylindrical shell 175, legs 171, 172, and a plurality of tension rods 81, lugs, 83, and tension bolt caps 82 of the floor tom drum 174. The base 71, a tuning key 72, a stem 73, and a cap 75 of the cymbal holder 70 are also visible.

FIG. 7 shows the rotational clips 1 being used to attach a stick holder 180 to a floor tom drum 174. The floor tom drum 174 has three legs 171, 172, 173. The stick holder 180 shown is representative, showing storage 182 for a plurality of drum sticks 181. This stick holder 180 can be zippered shut 184.

The stick holder 180 can be directly connected to the drum tensioners 80 directly using the rotational clips 1, or through using a slotted bracket 60 as previously disclosed.

FIG. 8 shows a drum kit with a bass drum 150, and snare drum 190 visible. Two rotational clips 1 are used with a slotted bracket 60 to mount a cowbell 160 on a bass drum 150.

Two rotational clips 1 are attached to the slotted bracket 60. The two rotational clips 1 attach the slotted bracket 60 to the tension rods 81 of two drum tensioners 80. The tension rods to which the two rotational clips 1 are attached are obscured by the slotted bracket 60, itself. Unobscured drum tensioners 80 are visible on the bass drum 150 near the head 153 and hoop 152. Again, a drum tensioner 80 is comprised of three pieces: the tension bolt 82, a tension rod 81, and a lug 83. The lug 83 is attached to the drum shell 151. The tension bolt 82 is attached to a piece of hardware 152 that keeps the head 153 in place, such as a hoop 152.

The cowbell holder 90 is comprised of a horizontal segment 93, a vertical segment 91, a bracket interface 94, and a tightening screw 92. The bracket interface 94 attaches to the slotted bracket 60. The horizontal segment 93 terminates in the bracket interface 94. The vertical segment goes through a hole that has a tightening screw 92. The cowbell holder 90 is attached to a slotted bracket 60 at the bracket interface 94. The first rotational clip 1 is placed in a hole 65 while the second rotational clip 1 is placed in a slot 61. The two rotational clips 1 are positioned on the slotted bracket 60 so that they are as far apart as two tension rods 81.

For each rotational clip 1 attached to a slotted bracket 60, the first and second approximately semi-cylindrical surfaces 26, 20 of the lower clip base 2 are capable of mating with the tension rod 81. A user aligns the beveled surfaces 28, 16 of the first and second approximately semi-cylindrical surfaces 26, 20 with the tension rod 81 and then twists the grasping face 33 of the twist fastener 3 in a clockwise direction. Due to the anti-rotation feature 30, the lower clip base 2 will rotate with the twist fastener 3 so that the tension rod is captured in the first and second approximately semi-cylindrical surfaces 26, 20. The beveled surfaces 28, 16 adjacent to each approximately semi-cylindrical surface 26, 20 facilitate the engagement between the tension rod 81 and the lower clip base 2. The retaining lip 18, 19 of the first and second approximately semi-cylindrical surfaces 26, 20 hold the tension rod 81 securely in place, and secure the slotted bracket 60 to the tension rods 81. In this way, the cowbell 160 and cowbell holder 90 are attached to the bass drum 150.

To remove the cowbell 160 and cowbell holder 90 from the bass drum 150, the user reverses the process, twisting the grasping face 33 of the twist fastener 3 of each rotational clip 1 in a counter-clockwise direction.

It is, of course, understood that the rotational clip 1 can be fashioned with the first and second approximately semi-cylindrical surfaces 26, 20 reversed, so that it is attached by rotating it in an counter-clockwise direction.

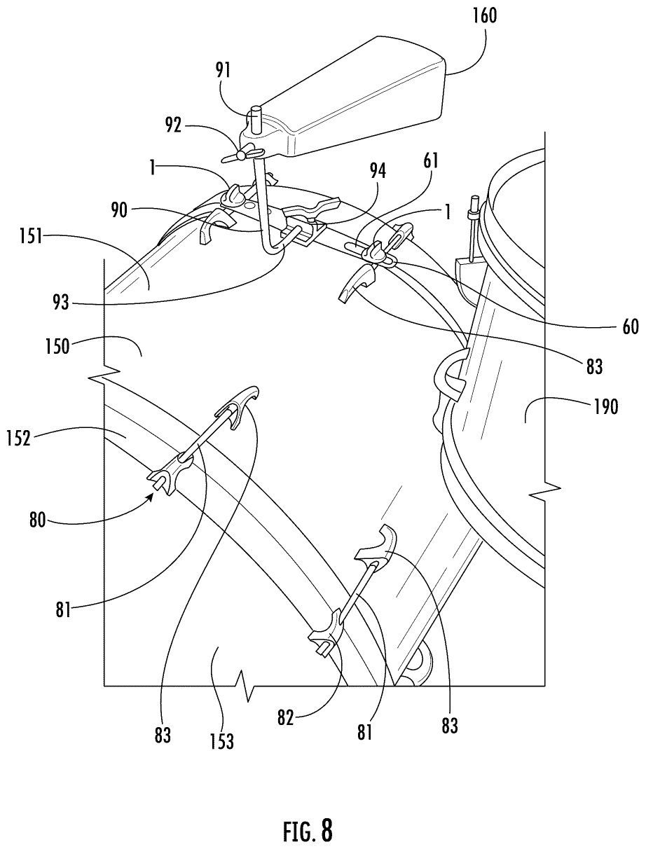

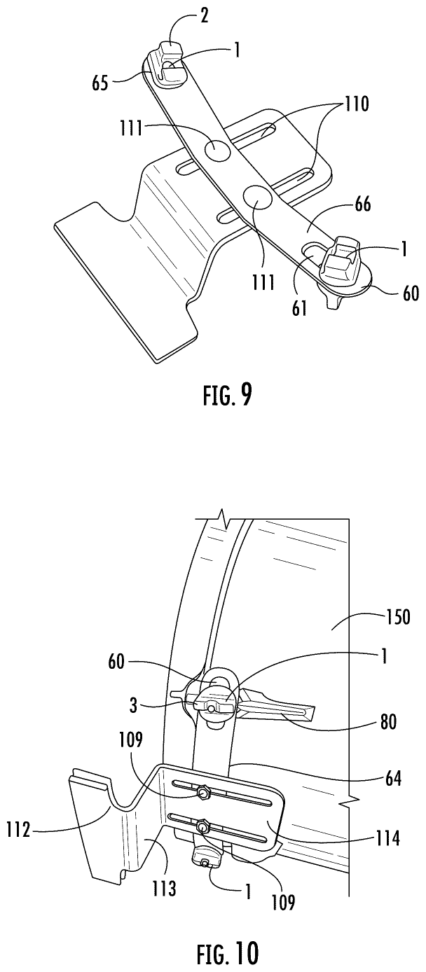

FIGS. 9-12 show the rotational clip 1 being used to attach a kick-pedal 161 to a bass drum 150. In FIGS. 9-10, the slotted bracket 60 is attached to the kick-pedal base 114 using threaded fasteners 111 and nuts 109. The second surface 66 of the slotted bracket 60 is facing outward in FIG. 9; the first surface 64 of the slotted bracket 60 is facing outward in FIG. 10. The threaded fasteners 111 fit through slots 110 in the kick-pedal base 114. A first rotational clip 1 is attached to the slotted bracket 60 through a hole 65; a second rotational clip 1 is attached to the slotted bracket 60 through a slot 61. In order to attach the kick-pedal base 114 and slotted bracket 60 assembly to the bass drum 150, a user aligns the beveled surfaces 28, 16 of the first and second approximately semi-cylindrical surfaces 26, 20 of the rotational clip 1 with the tension rod 81 of the tensioner 80 and then twists the grasping face 33 of the twist fastener 3 in a clockwise direction. Due to the anti-rotation feature 30, the lower clip base 2 will rotate with the twist fastener 3 so that the tension rod 81 is captured in the first and second approximately semi-cylindrical surfaces 26, 20. The retaining lip 18, 19 of the first and second approximately semi-cylindrical surfaces 26, 20 hold the tension rod 81 securely in place, and secure the slotted bracket 60 and kick-pedal base 114 to the tension rods 81.

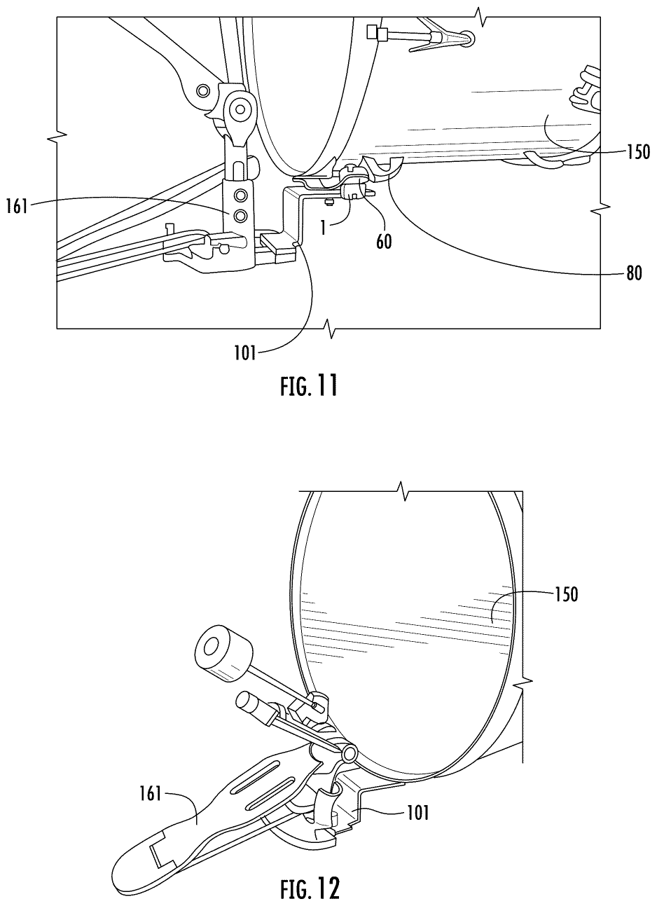

The kick-pedal base 114 has an extension 113 and a clamping surface 112. The twist fastener 3 is facing outward when the slotted bracket 60 is attached to the drum tensioner 80. FIGS. 11-12 show the kick-pedal 161 attached. The kick-pedal 161 has a clamp 101 that captures the clamping surface 112. In this way, the rotational clip 1 and slotted bracket 60 can be used to quickly attach a kick-pedal 161 to a bass drum 150.

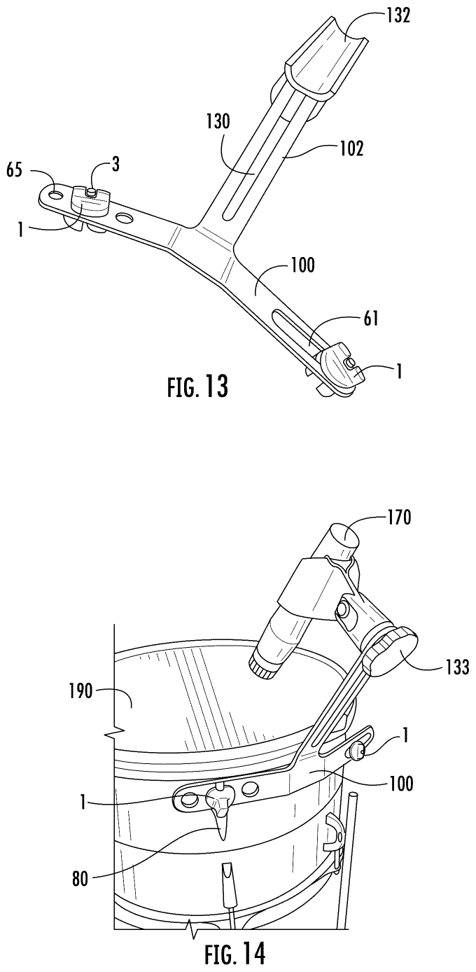

FIGS. 13-14 show two rotational clips 1 being used with a microphone holder 100, a specialized version of the slotted bracket The microphone holder 100 has a slot 61 and a plurality of holes 65 through which the rotational clips 1 may be fitted. The microphone holder 100 has an extension 102 with a slot 130, terminating in a microphone bed 132. The microphone holder 100 is attached to the drum tensioners 80 using the universal drum accessory mounts. The microphone 170 is pointed at the snare drum 190 and it can be adjusted up or down the slot 130 using a release knob 133.

I claim:

1. A rotational clip comprising
a lower clip base having an anti-rotational feature, an inner surface, a first approximately semi-cylindrical surface having a retaining lip, a second approximately semi-cylindrical surface having a retaining lip, a first beveled surface adjacent to the first approximately semi-cylindrical surface, and a second beveled surface adjacent to the second approximately semi-cylindrical surface;
a twist fastener having a top surface, a grasping face, and a mating feature inset;
wherein a threaded fastener and nut attaches the twist fastener to the lower clip base;
wherein the mating feature inset mates with the anti-rotational feature of the lower clip base and prevents the twist fastener and lower clip base from rotating independently of one another; and
wherein the first approximately semi-cylindrical surface and the second approximately semi-cylindrical surface are aligned in a straight line.

2. The rotational clip of claim 1, wherein the twist fastener and lower clip base are fabricated from at least one of poly(methyl-methacrylate) (“PMMA” or tradenames Plexiglass or Lucite®), polycarbonate (“PC” or tradename Lexan®), acrylonitrile butadiene styrene (“ABS”), polypropylene (“PP”), high-density polyethylene (“HDPE”), low-density polyethylene (“LDPE”), polyethylene (“PE”), polyethylene terephthalate (“PET”), and polylactic acid (“PLA”).

3. The rotational clip of claim 2, wherein the anti-rotation feature keeps the twist fastener and the lower clip base from rotating independently.

4. The rotational clip of claim 3, wherein a user can attach the rotational clip to a tension rod of a drum by aligning the beveled surfaces adjacent to the first and second approximately semi-cylindrical surfaces with the tension rod and then twisting the grasping face of the twist fastener.

5. The rotational clip of claim 4, wherein the retaining lip on each of the first and second approximately semi-cylindrical surfaces retains the tension rod.

6. The rotational clip of claim 5, wherein the rotational clip is rotated clockwise to attach it to a tension rod and it is rotated counter-clockwise to disengage it from a tension rod.

7. The rotational clip of claim 6, wherein the threaded fastener passes through a hole in the top surface of the twist fastener and a hole in the anti-rotation feature of the lower clip base emerging out the inner surface of the lower clip base; and wherein the nut is recessed in the inner surface of the lower clip base to secure the threaded fastener.

8. A universal drum accessory mount comprising
two rotational clips and
a slotted bracket having a first surface, a second surface, and at least two openings, the first of which is a slot;
wherein a first rotational clip is attached to a first opening in the slotted bracket and a second rotational clip is attached to a second opening in the slotted bracket;
wherein a drum accessory can be attached to the slotted bracket; and
the slotted bracket can be attached to a drum having a plurality of tension rods.

9. The universal drum accessory mount of claim 8,
wherein each rotational clip is comprised of
a twist fastener having a top surface, a second top surface, a grasping face, and a mating feature inset;
a lower clip base having an anti-rotational feature, an inner surface, a first approximately semi-cylindrical surface having a retaining lip, a second approximately semi-cylindrical surface having a retaining lip, a first beveled surface adjacent to the first approximately semi-cylindrical surface, and a second beveled surface adjacent to the second approximately semi-cylindrical surface; and
wherein, the first approximately semi-cylindrical surface and the second approximately semi-cylindrical surface are aligned in a straight line.

10. The universal drum accessory mount of claim 9 wherein the anti-rotation feature of the lower clip base mates with the mating feature inset of the twist fastener so that the twist fastener and the lower clip base cannot rotate independently of one another.

11. The universal drum accessory mount of claim 10, wherein the first rotational clip is disposed from the second rotational clip by a first distance in order that the universal drum accessory mount can be mounted on a drum having at least two tension rods being separated from one another by the first distance.

12. The universal drum accessory mount of claim 11, wherein the beveled surfaces adjacent to the first and second approximately semi-cylindrical surfaces of the first lower clip base are aligned with a first tension rod; and the beveled surfaces adjacent to the first and second approximately semi-cylindrical surfaces of the second lower clip base are aligned with a second tension rod.

13. The universal drum accessory mount of claim 12, wherein the first twist fastener is rotated, capturing the first tension rod in the first and second approximately semi-cylindrical surfaces of the first lower clip base.

14. The universal drum accessory mount of claim 13, wherein the second twist fastener is rotated, capturing the second tension rod in the first and second approximately semi-cylindrical surfaces of the second lower clip base.

15. The universal drum accessory mount of claim 14, wherein a cymbal holder is attached to the slotted bracket.

16. The universal drum accessory mount of claim 14, wherein a cowbell holder is attached to the slotted bracket.

17. The universal drum accessory mount of claim 14, wherein a microphone holder is attached to the slotted bracket.

18. The universal drum accessory mount of claim 14, wherein a kick-pedal for a bass drum is attached to the slotted bracket.
